(19) United States
(12) Patent Application Publication
(10) Pub. No.: US 2007/0000279 A1
(43) Pub. Date: Jan. 4, 2007

(54) Inline pipe filter and air conditioner comprising the same

(76) Inventor: Hyung Mo Koo, Suwon-Si (KR)

Correspondence Address: STANZIONE & KIM, LLP, 919 18TH STREET, N.W., SUITE 440, WASHINGTON, DC, 20006, US

(21) Appl. No.: 11/328,176

(22) Filed: Jan. 10, 2006

(30) Foreign Application Priority Data
Jul. 4, 2005 (KR) 2005-59857

(51) Int. Cl. F25B 43/00; B01D 24/00

(52) U.S. Cl. 62/474; 55/525

(57) ABSTRACT

An inline pipe filter and an air conditioner including the same. The inline pipe filter can be fitted into a refrigerant pipe with ease and convenience, and has a reinforced structure to endure pressure from the refrigerant applied thereto in alternating directions during heating and cooling operations. The inline pipe filter may include a ring-shaped cap, and a metal screen coupled to a periphery of the cap and having a plurality of minute holes. The metal screen may include a supporting member disposed around an inner peripheral surface of the metal screen so as to reinforce the metal screen. An inline pipe filter can be equipped to a refrigerant pipe connected to an inlet of an electronic expansion valve in an air conditioner. Another inline pipe can be fitted into a refrigerant pipe connected to an inlet of a compressor in the air conditioner.

### CROSS-REFERENCE TO RELATED APPLICATIONS

This application claims the benefit of Korean Patent Application No. 2005-59857, filed on Jul. 4, 2005 in the Korean Intellectual Property Office, the disclosure of which is incorporated herein by reference in its entirety.

### BACKGROUND OF THE INVENTION

1. Field of the Present General Inventive Concept

The present general inventive concept relates to air conditioning systems, and, more particularly, to an inline pipe filter, and an air conditioner comprising the same. An inline pipe filter according to one embodiment of the present general inventive concept is inserted into a pipe in the air conditioner with ease and convenience, and has a reinforced structure to resist damage by foreign substances and to prevent the foreign substances from being delivered to an electronic expansion valve or a compressor in the air conditioner.

2. Description of the Related Art

A typical air conditioner comprises various components such as a compressor, an outdoor heat exchanger, an indoor heat exchanger, an electronic expansion valve, and a plurality of refrigerant pipes connecting these components to cool or heat a room via heat exchanges performed by the outdoor and indoor heat exchangers. The plural refrigerant pipes have check valves to block flow of refrigerant, if necessary, and filters to restrict flow of foreign substances to prevent them from being introduced into the check vales because such foreign substances can interfere with opening or closing of the check valves or can damage the check valves.

In particular, the electronic expansion valve serving to decrease the pressure of liquid refrigerant has a very small hole formed therein, and the compressor serving to compress gaseous refrigerant comprises movable components, such as a rotational shaft or piston, which may be moving at a high speed. Thus, the filters must be equipped to the refrigerant pipe connected to the electronic expansion valve, and to the refrigerant pipe connected to the compressor in order to prevent the foreign substances contained within the circulating refrigerant from interfering with or damaging the electronic expansion valve and the compressor.

One example of conventional air conditioners comprising filters as described above is disclosed in Korean Patent Laid-open Publication No. 10-2004-0064451. The conventional air conditioner of this Korean laid-open publication has strainers and foreign substance blocking members acting as a filter equipped to a refrigerant pipe connected to an inlet of a compressor. A similar filter is also equipped to a refrigerant pipe that includes plural valves and is connected to an inlet of a distributor connected to an electronic expansion valve.

However, since the foreign substance blocking members of the conventional air conditioner are joined to the refrigerant pipes, it is necessary to join the foreign substance blocking members to the refrigerant pipes by a predetermined process, such as welding, thereby requiring additional costs as well as causing introduction of foreign substances into the refrigerant pipes during the joining process. Therefore, it is desirable to devise filters that can be inserted into the refrigerant pipe in a direction along a refrigerant flow path.

Moreover, when the air conditioner alternately performs a cooling operation and a heating operation, the refrigerant alternately flows in one direction while cooling and in the opposite direction while heating within the plural refrigerant pipes. Such bidirectional refrigerant flow in an alternating manner applies high pressure to the foreign substance blocking members in the filters, which may easily damage the foreign substance blocking members. Therefore, it is further desirable to devise an insertable filter that can withstand pressures from such alternating refrigerant flows.

### SUMMARY

The present general inventive concept provides an inline pipe filter, which can be equipped into a refrigerant pipe with ease and convenience, and has a reinforced structure to endure pressure of refrigerant applied in alternate directions. The present general inventive concept also contemplates an air conditioner comprising the inline pipe filter devised according to the teachings presented hereinbelow.

Additional aspects and/or utilities of the present general inventive concept will be set forth in part in the description which follows and, in part, will be obvious from the description, or may be learned by practice of the general inventive concept.

The foregoing and/or other aspects and utilities of the present general inventive concept are accomplished by providing an inline pipe filter that is insertable into a pipe. The filter includes a ring-shaped cap and a screen coupled to a periphery of the cap and having a plurality of minute holes therein. In an embodiment, the screen is a metal screen.

The metal screen may comprise a supporting member disposed around an inner peripheral surface of the metal screen to reinforce the metal screen. In an embodiment, the supporting member comprises a coil spring.

The metal screen and the supporting member may have a tapered shape. In an embodiment, the tapered shape has an appearance of a tapered cylindrical shape with a diameter gradually decreasing in a direction away from the cap.

The outer diameter of the cap may be the same as an inner diameter of the pipe, thereby allowing the cap to be press-fitted to an inner peripheral surface of the pipe.

In an alternative embodiment, the outer diameter of the cap is smaller than an inner diameter of the pipe, thereby allowing the cap to be fitted to an inner peripheral surface of the pipe by compressing the pipe at a location of the cap with force applied from the outside of the pipe.

The foregoing and/or other aspects of the present general inventive concept may also be achieved by providing a kit for an inline pipe filter that is insertable into a pipe. The kit may include a ring-shaped cap; and a screen to be coupled to a periphery of the cap and having a plurality of minute holes therein. In an embodiment, the kit may also include a supporting member configured to be disposed around an inner peripheral surface of the screen so as to provide reinforcement to the screen.

In a further embodiment, the present general inventive concept contemplates an air conditioner that includes a compressor; an outdoor heat exchanger; an indoor heat exchanger; an expansion valve; a first refrigerant pipe connecting the compressor to the outdoor heat exchanger; a second refrigerant pipe connecting the outdoor heat exchanger to the expansion valve; a third refrigerant pipe connecting the expansion valve to the indoor heat exchanger; a fourth refrigerant pipe connecting the indoor heat exchanger to the compressor; and an inline pipe filter coupled to one of the first, second, third, or fourth refrigerant pipes. The inline pipe filter includes a ring-shaped cap, and a screen coupled to a periphery of the cap and having a plurality of minute holes therein.

In a different embodiment, the present general inventive concept contemplates a pipe having an inline filter inserted therein. The inline filter includes a ring-shaped metallic cap, and a metal screen coupled to a periphery of the cap and having a plurality of minute holes therein.

In one embodiment, the present general inventive concept contemplates a method including providing an air conditioner with a plurality of refrigerant pipes and coupling an inline pipe filter to one of the plurality of refrigerant pipes in the air conditioner. The inline pipe filter includes a ring-shaped metallic cap, and a metal screen coupled to a periphery of the cap and having a plurality of minute holes therein.

The method may further include reinforcing the metal screen with a supporting member disposed around an inner peripheral surface of the metal screen.

### BRIEF DESCRIPTION OF THE DRAWINGS

These and/or other aspects and advantages of the present general inventive concept will become apparent and more readily appreciated from the following description of the embodiments, taken in conjunction with the accompanying drawings, of which:

FIG. 1 is a schematic diagram illustrating the construction of a heat pump type air conditioner having inline pipe filters according to the present general inventive concept;

FIG. 2 is a perspective view illustrating the inline pipe filter according to FIG. 1;

FIG. 3 is a view illustrating the inline pipe filter press-fitted into a pipe according to the present general inventive concept; and

FIG. 4 is a view illustrating the inline pipe filter compressed into a pipe according to the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

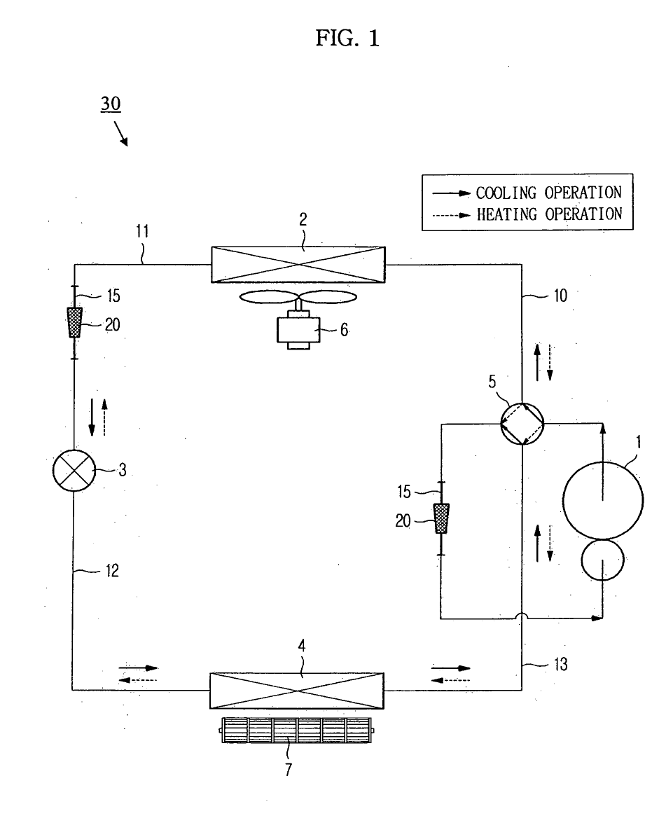

FIG. 1 is a schematic diagram illustrating the construction of a heat pump type air conditioner 30 having inline pipe filters 15 according to the present general inventive concept. In FIG. 1, the air conditioner 30 includes a number of components including a compressor 1, an outdoor heat exchanger 2, an electronic expansion valve 3, an indoor heat exchanger 4, a 4-way valve 5, and a plurality of refrigerant pipes 10, 11, 12 and 13 connecting these components, as shown in FIG. 1, to accomplish cooling or heating of a room.

The 4-way valve 5 is placed between the refrigerant pipes 10 and 13 to convert flow of refrigerant upon a cooling or heating operation. The air conditioner 30 further includes outdoor and indoor blowing fans 6 and 7 placed near the outdoor and indoor heat exchangers 2 and 4, respectively, such that outdoor air and indoor air are subjected to heat exchange through the outdoor and indoor heat exchangers 2 and 4.

In FIG. 1, as indicated by solid arrows, when the air conditioner 30 is performing a cooling operation, the outdoor heat exchanger 2 serves as a condenser to convert a gaseous refrigerant compressed to a high temperature and pressure by the compressor 1 to a liquid refrigerant via heat exchange with outdoor air by the blowing fan 6. The indoor heat exchanger 4, on the other hand, serves as an evaporator to convert the liquid refrigerant having lower temperature and pressure to the gaseous refrigerant via heat exchange with indoor air by the blowing fan 7. This results in the liquid refrigerant absorbing heat from the indoor air through the indoor heat exchanger 4, thereby cooling the room.

On the other hand, as indicated by dotted arrows, when the air conditioner 30 is performing a heating operation, the outdoor heat exchanger 2 serves as the evaporator to convert the liquid refrigerant having lower temperature and pressure to the gaseous refrigerant via heat exchange with outdoor air by the blowing fan 6. During this heating operation, the indoor heat exchanger 4 serves as the condenser to convert the gaseous refrigerant compressed to have high temperature and pressure by the compressor 1 to the liquid refrigerant via heat exchange with indoor air by the blowing fan 7. This results in the gaseous refrigerant discharging heat to the indoor air through the indoor heat exchanger 4, thereby heating the room.

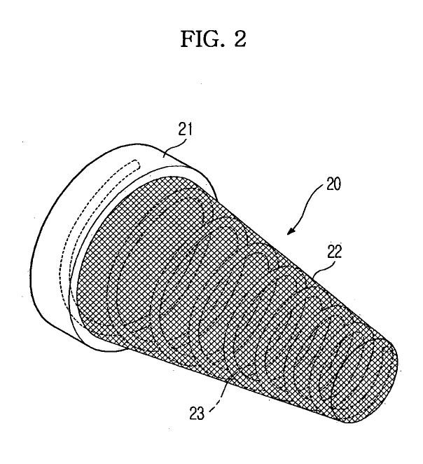

To prevent foreign substances contained within the refrigerant in circulation from blocking the compressor 1 and the electronic expansion valve 3 and from interfering with or damaging them, the air conditioner 30 according to an embodiment of the present general inventive concept includes inline pipe filters 20 inserted into one-piece pipes (also referred to herein as “coupling pipes”) 15. In the embodiment of FIG. 1, corresponding one-piece pipes 15 are coupled to the refrigerant pipe 11 near the electronic expansion valve 3 and to the refrigerant pipe 13 near a suction port of the compressor 1, respectively. The coupling pipes 15, as shown in FIG. 1, may be connected to respective refrigerant pipes in such a manner as to form an integral portion of the corresponding refrigerant pipe as shown, for example, with reference to the refrigerant pipe 11 in FIG. 1. In an alternative embodiment (not shown) of the present general inventive concept, the inline pipe filters 20 may be inserted directly into respective refrigerant pipes 11 and 13 without employing the coupling one-piece pipes 15. The constructional details of the inline pipe filter 20 will be described with reference to FIGS. 2 to 4 as follows.

FIG. 2 is a perspective view illustrating an inline pipe filter 20 according to the present general inventive concept. In FIG. 2, the inline pipe filter 20 of the present general inventive concept has a predetermined length, and includes a ring-shaped metallic cap 21 formed to allow fluid or refrigerant to pass therethrough, a metal screen 22 coupled to a periphery of the cap 21 and extending in a longitudinal direction, and a supporting member 23 disposed around an inner peripheral surface of the metal screen 22.

The metal screen 22 includes a number of minute holes, and has an elongated length (in the longitudinal direction) much greater than the diameter of the cap 21, so that sufficient fluid or refrigerant can pass through the metal screen 22 at a high speed.

The supporting member 23 is equipped to reinforce the metal screen 22 because the metal screen 22 can be easily deformed by force applied, in particular, to a side of the metal screen 22. In the embodiment of FIGS. 2-4, the supporting member 23 includes a spirally wound coil spring. Alternatively, although not shown in the drawings, the supporting member 23 may comprise a plurality of bars, wherein each bar is width-wise (diametrically) coupled to the inner peripheral surface of the metal screen 22 and placed at a predetermined spatial location along the longitudinal direction of the filter 20 from the cap-end of the metal screen 22 to the other end of the metal screen 22. Each bar may diametrically extend up to the inner peripheral surface to provide requisite reinforcement. In an embodiment of the present general inventive concept, the bars (not shown) may be metallic bars that are placed inside the metal screen 22 and having longitudinal spatial separation similar to the spacing between each pair of windings of the coil spring shown in FIG. 2.

As described above, the supporting member 23 in the embodiment of FIGS. 2-4 comprises the coil spring so that it can support the metal screen 22 with high strength in a radial direction as well as in an axial direction, and can sufficiently absorb pressure and impact of the fluid applied to the metal screen 22 via resilience of the coil spring. Such resilience of the supporting member 23 allows it not to be deformed by the alternating fluid flow and pressure during heating and cooling operations

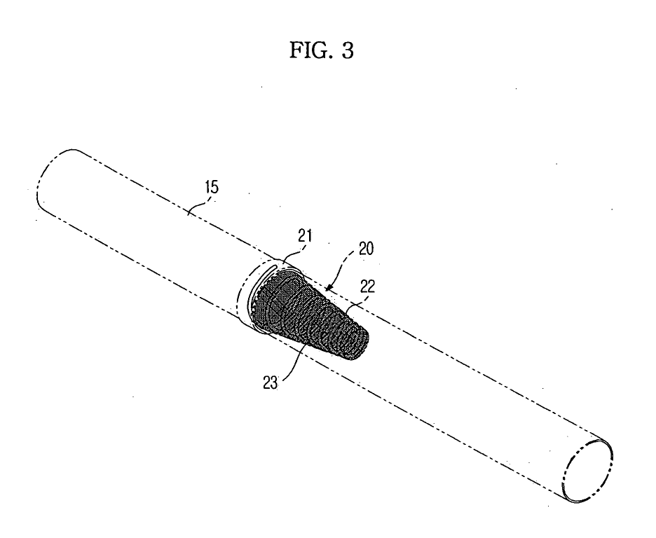

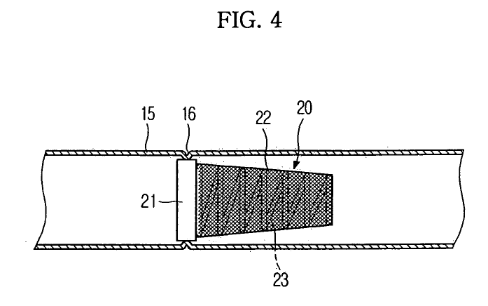

In the embodiment of FIGS. 2-4, the supporting member 23 and the metal screen 22 are shown having a tapered shape. The tapered shape may have an appearance of a tapered cylindrical shape having a diameter gradually decreasing in a direction away from the cap 21 so that, when the filter 20 is equipped into the pipe 15, a predetermined space is formed between an outer peripheral surface of the metal screen 22 and an inner peripheral surface of the pipe 15 as shown, for example, in FIGS. 3 and 4.

The inline pipe filter 20 according to an embodiment of the present general inventive concept is press-fitted or compressed into the pipe 15 as described hereinbelow with reference to FIGS. 3 and 4.

FIG. 3 is a view illustrating the inline pipe filter 20 press-fitted into the coupling pipe 15 according to an embodiment of the present general inventive concept, and FIG. 4 is a view illustrating the inline pipe filter 20 compressed into the coupling pipe according to another embodiment of the present general inventive concept.

In FIG. 3, the inline pipe filter 20 according to the present general inventive concept is shown press-fitted into the pipe 15 that has a predetermined inner diameter. In the embodiment of FIG. 3, the cap 21 of the filter 20 has the same outer diameter as an inner diameter of the pipe 15, so that the filter 20 is fitted into the pipe 15 with convenience and ease by press-fitting the filter 20 into the pipe 15.

On the other hand, in FIG. 4, the inline pipe filter 20 according to another embodiment of the present general inventive concept is shown compressed into the pipe 15 that has a predetermined inner diameter. In the embodiment of FIG. 4, the cap 21 of the filter 20 has a smaller outer diameter than the inner diameter of the pipe 15. With such differing configurations, a groove 16 may be formed in the pipe 15, and the cap 21 may be fitted into the inner peripheral surface of the pipe 15 by suitably compressing an outer side of the pipe 15 at a portion where the cap 21 of the filter 20 is located in the pipe 15 after pushing the filter 20 into the pipe 15, so that the filter 20 is fitted into the pipe 15 with convenience and ease.

When the air conditioner 30 having the inline pipe filter 20 of the present general inventive concept is operated for cooling a room, foreign substances contained in the refrigerant are filtered by and collected on the inner peripheral surface of the metal screen 22 while the refrigerant flows into the inner peripheral surface of the metal screen 22 through a hollow of the cap 21. When the air conditioner 30 having the inline pipe filter 20 of the present general inventive concept is operated for heating the room, foreign substances contained in the refrigerant are now filtered by and collected on the outer peripheral surface of the metal screen 22 while the refrigerant flows into the inner peripheral surface of the metal screen 22 and the hollow of the cap 21 through the outer peripheral surface of the metal screen 22.

Although the air conditioner 30 has been described as having a single indoor heat exchanger and a compressor in the embodiment of FIG. 1, it should be noted that the present general inventive concept is not limited to the air conditioner as described above. On the contrary, the teachings of the present general inventive concept can be applied to a multi-type air conditioner including plural indoor heat exchangers and compressors. Additionally, in the above description, although the inline pipe filter 20 according to the present general inventive concept is illustrated as being equipped or fitted only to refrigerant pipes connected to the compressor 1 and the electronic expansion valve 3, it should be noted that the inline pipe filter 20 can be fitted to refrigerant pipes connected to the indoor and outdoor heat exchangers 2 and 4, and to the check valves (not shown) as well.

One of the utilities of the present general inventive concept is that the inline pipe filter 20 has the ring-shaped cap 21 and the metal screen 22, and the filter 20 can be equipped into the refrigerant pipe with convenience and ease, thereby reducing assembly costs and preventing foreign substances from being introduced into the refrigerant.

Another utility of the present general inventive concept is that the air conditioner 30 constructed according to the teachings of the present general inventive concept may include the inline pipe filter with the metal screen supported by the supporting member such as, for example, a spirally-wound coil spring. Therefore, when the air conditioner alternately performs a cooling operation and a heating operation, which apply pressures to the refrigerant in alternating directions (forward and reverse), the metal screen is not deformed or broken by the foreign substances, thereby preventing damage to the electronic expansion valve and the compressor.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inline pipe filter insertable into a pipe, the filter comprising:
a ring-shaped cap; and
a screen coupled to a periphery of the cap and having a plurality of minute holes therein.

2. The inline pipe filter according to claim 1, wherein the ring-shaped cap is made of metal.

3. The inline pipe filter according to claim 1, wherein the screen is a metal screen.

4. The inline pipe filter according to claim 3, wherein the metal screen comprises a supporting member disposed around an inner peripheral surface of the metal screen to reinforce the metal screen.

5. The inline pipe filter according to claim 4, wherein the supporting member comprises a coil spring.

6. The inner pipe filter according to claim 4, wherein the supporting member comprises a plurality of metallic bars, wherein each metallic bar diametrically extends up to the inner peripheral surface and is placed at a predetermined spatial location along a longitudinal length of the metal screen.

7. The inline pipe filter according to claim 4, wherein the metal screen and the supporting member have a tapered shape.

8. The inner pipe filter according to claim 7, wherein the tapered shape has an appearance of a tapered cylindrical shape with a diameter gradually decreasing in a direction away from the cap.

9. The inline pipe filter according to claim 1, wherein an outer diameter of the cap is the same as an inner diameter of the pipe, thereby allowing the cap to be press-fitted to an inner peripheral surface of the pipe.

10. The inline pipe filter according to claim 1, wherein an outer diameter of the cap is smaller than an inner diameter of the pipe, thereby allowing the cap to be fitted to an inner peripheral surface of the pipe by compressing the pipe at a location of the cap with force applied from the outside of the pipe.

11. An air conditioner comprising:
a compressor;
an outdoor heat exchanger;
an indoor heat exchanger;
an expansion valve;
a first refrigerant pipe connecting the compressor to the outdoor heat exchanger;
a second refrigerant pipe connecting the outdoor heat exchanger to the expansion valve;
a third refrigerant pipe connecting the expansion valve to the indoor heat exchanger;
a fourth refrigerant pipe connecting the indoor heat exchanger to the compressor; and
an inline pipe filter coupled to at least one of the first, second, third, or fourth refrigerant pipes, wherein the inline pipe filter comprises:
a ring-shaped cap; and
a screen coupled to a periphery of the cap and having a plurality of minute holes therein.

12. The air conditioner according to claim 11, wherein the ring-shaped cap is made of metal.

13. The air conditioner according to claim 11, wherein the screen is a metal screen.

14. The air conditioner according to claim 13, wherein the metal screen comprises a supporting member disposed around an inner peripheral surface of the metal screen to reinforce the metal screen.

15. The air conditioner according to claim 14, wherein the supporting member comprises one of the following:
a coil spring; and
a plurality of metallic bars, wherein each metallic bar diametrically extends up to the inner peripheral surface and is placed at a predetermined spatial location along a longitudinal length of the metal screen.

16. The air conditioner according to claim 14, wherein the metal screen and the supporting member have a tapered shape.

17. The air conditioner according to claim 16, wherein the tapered shape has an appearance of a tapered cylindrical shape with a diameter gradually decreasing in a direction away from the cap.

18. The air conditioner according to claim 11, further comprising:
a coupling pipe connected to form a portion of the one of the first, second, third, or fourth refrigerant pipes, wherein the coupling pipe has the inline pipe filter inserted therein.

19. The air conditioner according to claim 18, wherein an outer diameter of the cap is the same as an inner diameter of the coupling pipe, thereby allowing the cap to be press-fitted to an inner peripheral surface of the coupling pipe.

20. The air conditioner according to claim 18, wherein an outer diameter of the cap is smaller than an inner diameter of the coupling pipe, thereby allowing the cap to be fitted to an inner peripheral surface of the coupling pipe by compressing the coupling pipe at a location of the cap with force applied from the outside of the coupling pipe.
